(19) United States
(12) Patent Application Publication
(10) Pub. No.: US 2008/0302767 A1
(43) Pub. Date: Dec. 11, 2008

(54) Plasma Cutting Machine

(75) Inventors: Yoshihiro Yamaguchi, Ishikawa (JP); Kazuhiro Kuraoka, Ishikawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KOMATSU INDUSTRIES CORPORATION, Komatsu-shi (JP)

(21) Appl. No.: 11/631,513

(22) PCT Filed: Jun. 2, 2005
(86) PCT No.: PCT/JP2005/010174

§ 371 Date: Jan. 4, 2007

(30) Foreign Application Priority Data
Jul. 5, 2004 (JP) 2004-198205

(51) Int. Cl. B23K 10/00

(52) U.S. Cl. 219/121.44; 219/121.39; 219/121.55

(57) ABSTRACT

A plasma cutting machine cuts stainless steel with good quality. An inactive gas (nitrogen) is supplied as a plasma gas, and a combustible gas (propane) having a specific gravity higher than that of air and having a reducing ability or a mixed gas of the combustible gas (propane) and an inactive gas (nitrogen) is supplied as an assist gas to a plasma torch. The combustible gas (propane) contained in the assist gas is not supplied in the pre-flow interval and after-flow interval, and is supplied only in the plasma arc generation interval.

### TECHNICAL FIELD

The present invention relates to a plasma cutting method for cutting stainless steel and to a plasma cutting machine for cutting stainless steel by implementing the method.

### BACKGROUND ART

In plasma cutting of stainless steel, chromium contained in the stainless steel is oxidized during cutting and the chromium oxides adhere to the cut surface due to poor flowability of the oxides, thereby degrading the quality of the cut surface. The following conventional technologies relating to the composition of plasma gas and assist gas is known as means for resolving the aforementioned problem. With the first conventional technology, nitrogen or air is used as a plasma gas and methane or a mixture of methane and air is used as an assist gas (U.S. Pat. No. 5,414,236). With the second conventional technology, air or a mixed gas of air and nitrogen is used as a plasma gas and hydrogen, a hydrogen-containing mixed gas, or a carbonated hydrogen gas is used as an assist gas (Japanese Patent Application No. H9-295156).

With the first conventional technology, the methane or a mixture gas of methane and air that is used as an assist gas is expected to prevent the oxidation of the cut surface due to a reducing ability of methane. However, because methane has a specific gravity lower than that of air, when methane is supplied as a shield gas around the plasma arc, the methane can be easily affected by the external air flow or wind. Furthermore, the methane gas easily diffuses and can affect the shielding effect of the stainless steel that was cut.

With the second technology, using hydrogen, a hydrogen-containing mixed gas, or a carbonated hydrogen gas as an assist gas is expected to inhibit the oxidation of the cut surface due to the reducing ability of those gases. However, because hydrogen also has a specific gravity lower than that of air, when hydrogen or hydrogen-containing mixed gas is supplied as a shield gas around the plasma air, the hydrogen can be easily affected by the external air flow or wind. Furthermore, hydrogen easily diffuses and can affect the shielding effect on the stainless steel that was cut. Actual tests carried out by the inventors demonstrated that chromium oxides locally adhere to the cut surface and good nonoxidized cut surface is extremely difficult to obtain. Even when tiny amounts of chromium oxides are present on the cut surface of commercial products, the commercial value of the products is greatly reduced. For this reason, there is a strong demand for a technology capable of yielding good nonoxidized cut surface superior to that obtained with the conventional technology.

Furthermore, in most plasma cutting plants, not only stainless steel, but also soft steel is cut. In plasma cutting of soft steel, by contrast with stainless steel, it is preferred to cause active oxidation (combustion) of the steel and employ the oxidation heat for cutting. For this reason, oxygen gas is most often used. However, in the plants using such oxygen gas, the user is strongly required to avoid using hydrogen gas. For this reason, the conventional technology employing hydrogen gas or a mixed gas thereof as an assist gas is difficult to use.

Furthermore, a significant problem associated with using a carbonated hydrogen gas suggested by the second conventional technology as a shield gas is that the flowability of molten metal generated during cutting is degraded and the molten metal adheres to the rear surface of the product.

### DISCLOSURE OF THE INVENTION

Accordingly, it is an object of the present invention to provide a plasma cutting machine for cutting stainless steel with good quality and a cutting method using the plasma cutting machine. Other objects of the present invention will become clear from the description of embodiments hereinbelow.

The plasma cutting machine in accordance with the present invention comprises a control unit for performing control of a gas supply operation, and gas supply system for supplying an inactive gas as a plasma gas to be ejected as plasma arc from a nozzle of a plasma torch and a combustible gas having a specific gravity higher than that of air and having a reducing ability or a mixed gas of the combustible gas and an inactive gas as an assist gas for shielding the plasma arc from external air to the plasma torch in response to an instruction from the control unit. With the plasma cutting machine in accordance with the present invention, because the plasma gas is an inactive gas, this gas by itself does not become the source of cut surface oxidation. In addition, due to the shielding action and reduction action of the assist gas that is a combustible gas having a specific gravity higher than that of air and having a reducing ability or a mixed gas of the combustible gas and an inactive gas, oxidation prevention and reduction of the cut surface are effectively performed. Such combined action of the plasma gas and assist gas ensures high quality of the cut product.

In the preferred embodiment, nitrogen is employed as the inactive gas used as the plasma gas. Furthermore, propane gas is employed as a combustible gas having a specific gravity higher than that of air and having a reducing ability. A mixed gas of nitrogen and propane is employed as the assist gas.

In the preferred embodiment, the controller controls the gas supply system so that, from among a series of a pre-flow interval, a plasma arc generation interval, and an after-flow interval, the combustible gas is supplied into the plasma torch in the plasma arc generation interval, and the combustible gas is not supplied to the plasma torch in the pre-flow interval or the after-flow interval. Therefore, the combustible gas used as the assist gas cannot be discharged in a large amount to the outside in a non-combusted state.

In the preferred embodiment, the gas supply system comprises a plasma gas line for supplying the plasma gas to the plasma torch and an assist gas line for supplying the assist gas to the plasma torch, and the assist guide line is connected to a merging point where a combustible gas line for supplying the combustible gas merges with an inactive gas line for supplying the inactive gas in the vicinity of the plasma torch. Further, gas flow controller for controlling the flow of the combustible gas in response to an instruction from the controller is disposed in the combustible gas line in the vicinity of the merging point. With such configuration, the above-described gas flow control in which the combustible gas is supplied in the plasma arc generation interval and is not supplied in the pre-flow interval or after-flow interval can be conducted timely and without a large time delay.

The plasma cutting method in accordance with another aspect of the present invention comprises a step of supplying an inactive gas as a plasma gas to a plasma torch and a step of supplying a combustible gas having a specific gravity higher than that of air and having a reducing ability or a mixed gas of the combustible gas and an inactive gas as an assist gas to the plasma torch.

With the plasma cutting apparatus and method in accordance with the present invention, good cutting quality can be obtained in plasma cutting stainless steel.

### BRIEF DESCRIPTION OF THE DRAWINGS

FIG. 1 illustrates a schematic configuration of the plasma cutting machine of one embodiment of the present invention;

FIG. 2 is a time chart illustrating an example of a procedure for supplying a plasma gas and also nitrogen gas and propane gas contained in the assist gas in the gas supply process.

### BEST MODE FOR CARRYING OUT THE PRESENT INVENTION

An embodiments of the present invention will be explained below with reference to the appended drawings. In the embodiments, as described hereinbelow, using an inactive gas, for example nitrogen, as a plasma gas and using a combustible gas having a specific gravity higher than that of air and having a reducing ability or a mixed gas of the combustible gas and an inactive gas, for example a mixed gas of nitrogen and propane, as an assist gas make it possible to cut stainless steel with good quality.

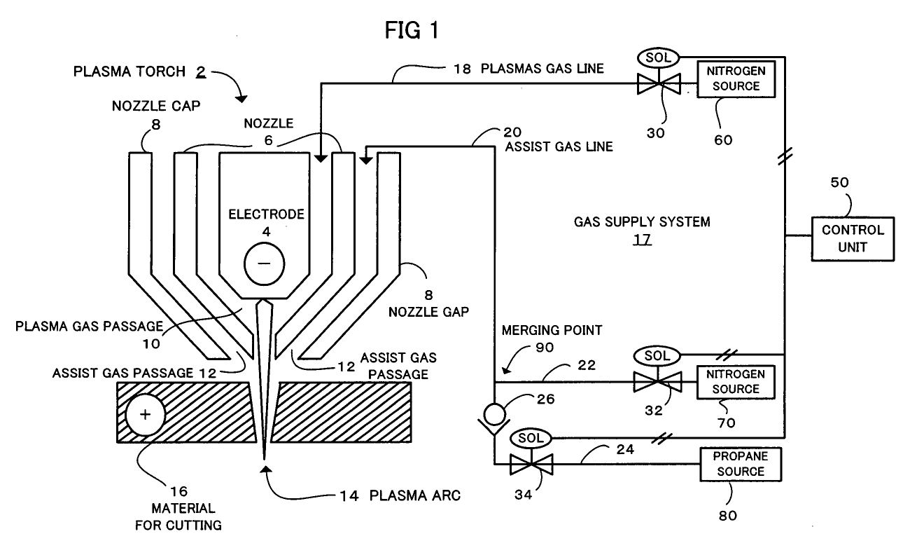

FIG. 1 illustrates a schematic configuration of the plasma cutting machine of one embodiment of the present invention.

A plasma torch 2, as shown in FIG. 1, as a whole has a multiple tubular shape and comprises an electrode 4 in the central position thereof. The electrode 4 is covered from the outside with a nozzle 6, and a nozzle gap 8 is formed on the outside of the nozzle 6. A gas supply system 17 is connected to the plasma torch 2.

The gas supply system 17 has a plasma gas line 18 for supplying a plasma gas to the plasma torch 2 and an assist gas line 20 for supplying an assist gas to the plasma torch 2. The plasma gas line 18 is connected to a nitrogen source (for example, a nitrogen cylinder) 60. The assist gas line 20 is connected to a merging point 90 where a nitrogen gas line 22 for supplying nitrogen gas merges with a propane gas line 24 for supplying propane gas in a location close to the plasma torch 2. The nitrogen gas line 22 is connected to a nitrogen source (for example nitrogen cylinder) 70 (may be the same source as the nitrogen source 60 for the plasma gas mentioned above, or a separate source). The plasma gas line 18 is provided with an electromagnetic valve 30 for starting and stopping the supply of the plasma gas, the nitrogen gas line 22 is provided with an electromagnetic valve 32 for starting and stopping the supply of nitrogen gas constituting the assist gas, and the propane gas line 24 is provided with an electromagnetic valve 34 for starting and stopping the supply of propane gas constituting the assist gas. A stop valve 26 for preventing nitrogen from flowing into the propane line is provided between the electromagnetic valve 34 of the propane gas line 24 and the merging point 90. The mechanism comprising the electromagnetic valve 34 and stop valve 26 located on the propane line 24 and serving to control the flow of propane gas is disposed in the vicinity of the merging point 90.

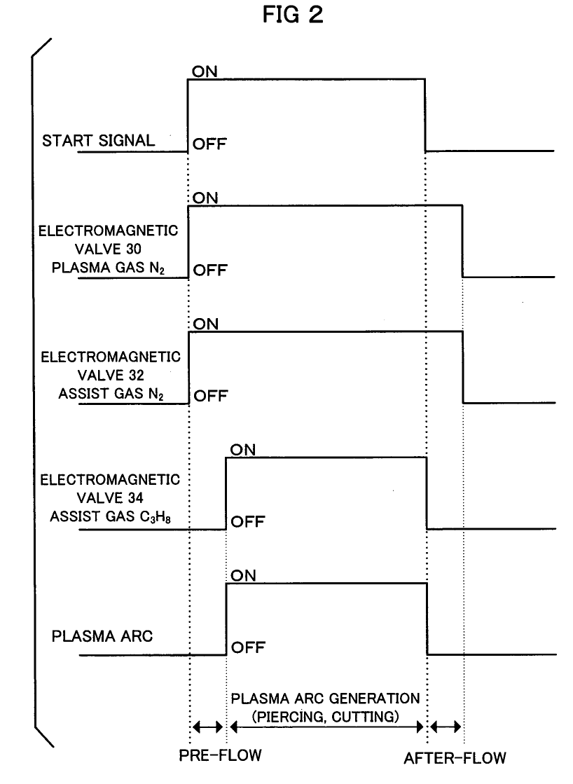

A control unit 50 for controlling the gas supply operation is connected to the gas supply system 17. The control unit 50 open-close controls the above-described electromagnetic valves 30, 32, 34 in the gas supply process for torch drive that is composed of a series of a pre-flow interval, a plasma arc generation interval, and an after-flow interval according to a procedure such that will be explained hereinbelow with reference to FIG. 2.

In the plasma torch 2, a plasma gas passage 10 is formed between the electrode 4 and nozzle 6. When the electromagnetic valve 30 is opened in response to the instruction from the control unit 50, the plasma gas (nitrogen gas) flows from the nitrogen source 60 through the plasma gas line 18 and is supplied to the plasma gas passage 10 of the plasma torch 2. Furthermore, an assist gas passage 12 is formed between the nozzle gap 8 and nozzle 6 of the plasma torch 2. When the electromagnetic valve 32 and electromagnetic valve 34 are opened in response to the instruction from the control unit 50, the nitrogen gas that flowed from the nitrogen source 70 via the nitrogen line 22 merges with the propane gas that flowed from the propane source 80 via the propane line 24 in the merging point 90, and the mixed gas obtained is supplied through the assist gas line 20 to the assist gas passage 12 of the plasma torch 2 (as described hereinbelow, the assist gas comprises only the nitrogen gas and no propane gas in the pre-flow section and after-flow section).

Nozzle 6 is a component having the smallest gas ejection orifice for restricting a plasma arc 14 and throttling the plasma gas supplied from the side upstream of the nozzle 6. The plasma gas ejected from the gas ejection orifice is converted into plasma by an arc discharge between the electrode 4 and the material for cutting 16, becomes the plasma arc 14 of a high-speed jet flow throttled to a sufficiently small size, and is ejected toward the material for cutting (stainless steel) 16. The stainless steel is cut by the plasma arc 14.

On the other hand, the nozzle gap 8 is a component having a gas ejection orifice disposed downstream of the nozzle 6 and having a radius larger than the gas ejection orifice of the nozzle 6 and serves to eject the assist gas flowing in from the assist gas passage 12 between the nozzle gap 8 and nozzle 6 to the area around the plasma arc 14. The assist gas ejected from the assist gas passage 12 encloses the plasma ark 14, without conversion to the plasma. The assist gas acts to shield the plasma arc 14 from the external air so that the plasma arc 14 is not affected by external wind or air flow when the plasma arc 14 cuts the stainless steel. Furthermore, due to a reducing action of the propane gas that has a strong reducing ability and is contained in the assist gas, the assist gas also prevents oxidation of the stainless steel that was cut by the plasma arc 14 or produces a reducing effect.

Whether the cut surface is oxidized is one of the characteristics emphasized in terms of cutting quality of stainless steel. The presence of oxidation can be judged by the metal gloss or color of the cut surface in visual observations. When the cut surface is of a silver white color, has no other coloration or dull sections, and has a sufficient metal gloss (in other words, if the base metal of stainless steel is entirely exposed), such surface is judged to be a good nonoxidized cut surface. The commercial value of cut products of stainless steel decreases significantly if gray color is present even on a tiny portion of the cut surface (that is, if slight amounts of chromium oxides have adhered to the surface). The type of gases used for the plasma gas and assist gas is an important factor greatly affecting the quality of cut products.

The composition of the gas used in the plasma cutting machine of the present embodiment will be described below in greater detail from the standpoint of cut product quality.

An inactive gas containing no oxygen, for example, nitrogen with a substantial volume concentration (molar concentration) of 100% is used for the plasma gas. Where an oxygen-containing gas (for example, air or a mixed gas of oxygen and other gases) is used, such gas cancels the reducing ability of the assist gas and a nonoxidized cut surface is difficult to obtain. By contrast, if a pure inactive gas with a volume concentration of substantially 100%, for example nitrogen gas, is used, the reducing ability of the assist gas is not canceled and, therefore, the nonoxidized cut surface is easy to obtain. According to this principle, an inactive gas other than nitrogen, for example, argon can be also used as the plasma gas. Comparison of nitrogen and argon demonstrates that nitrogen provides for a higher heat quantity of plasma arc and increases the cutting capacity. This is because nitrogen, which has a two-atom molecule, produces higher heat capacity during conversion into plasma than argon, which has a single-atom molecule.

Furthermore, an inactive gas and a combustible gas having a specific gravity higher than that of air and having a reducing ability or a mixed gas of the combustible gas and an inactive gas, for example, a mixed gas of nitrogen and propane, can be used as the assist gas. The volume concentration (molar concentration) of propane in the assist gas is preferably 50% or less. For example, the mixture with the concentration of 20% or 30% can be employed. If the volume concentration of propane increases, the flowability of the molten metal is degraded, easily causing the adhesion of the molten metal to the rear side of the product. The above-described concentration is preferred to resolve this problem. The research conducted by the inventors demonstrated that propane gas is apparently the optimum gas, from among the reducing gases of various types, to be contained in the assist gas for plasma cutting stainless steel. The reason therefore is as follows. The experiments conducted by the inventors demonstrated that when plasma cutting of stainless steel was actually carried out by using the combination of the plasma gas and assist gas of the above-described composition, a very good nonoxidized cut surface could be judged to be obtained based on visual observations of the cut surface. On the other hand, when another reducing gas, for example hydrogen gas, was used instead of the propane gas in the experiments carried by the inventors, the nonoxidized cut surface obtained could not be judged as good as that obtained with the propane gas, based on visual observations of the cut surface, because certain dullness and gray color were observed on the cut surface. A good nonoxidized cut surface can be obtained by using the propane gas supposedly for the following reasons.

Firstly, propane comprises a larger number of hydrogen atoms than hydrogen or methane and ethane (hydrocarbons) that were suggested within the framework of the above-described conventional technology. Therefore, a stronger reducing action can be assumed to be produced, this action preventing the oxidation of the cut surface after cutting and further reducing the surface.

Secondly, because propane has a specific gravity larger than that of air (1.5 times that of air), the propane apparently better protects the plasma arc 14 from the effect of external air flow or wind and provides for higher shielding capacity, thereby preventing oxygen of the external air from penetrating to the cutting interval, than hydrogen or methane that is lighter than air or ethane that has a specific gravity almost equal to that of air. When the gas lighter than air is used, the gas diffuses easily and the shielding effect of the cut surface and plasma arc 14 by the reducing ability of the gas is easily decreased under the effect of wind or air flow. On the other hand, propane, which is heavier than air, does not diffuse that easily and maintains good shielding effect.

Thirdly, propane is a gas that is not liquefied under the assist gas supply pressure. Thus, based only on the requirements that the gas be hydrocarbon, have a large number of hydrogen atoms, and be heavier than air, butane that contains larger number of hydrogen atoms and is heavier than propane and other hydrocarbon gases with a higher molecular weight would yield excellent results. However, in order to supply the assist gas to the plasma torch 2, usually a gas supply pressure of at least 1 to 2 kg/cm² as a gage pressure (absolute pressure 2 to 3 kg/cm²) is necessary. Because the vapor pressure of butane at 25° C. is 1.8 kg/cm², butane is liquefied under a supply pressure of the assist gas and cannot be supplied as a gas. Because other hydrocarbon gases with a higher molecular weight have even lower vapor pressure and even easier liquefied, they cannot be used as an assist gas. By contrast, because propane has a vapor pressure of 8.5 kg/cm² at 25° C., it can be readily supplied as a gas under the above-described assist gas supply pressure.

Propane also has the following advantages over other reducing gases. Thus, when compared with hydrogen, propane is used as a LP gas (liquefied petroleum gas), for example, as a stove burner and is superior in terms of safety, availability, and cost efficiency. Furthermore, in terms of availability, the aforementioned butane is also inferior to propane. Moreover, as described above, the concentration of propane necessary to obtain a good nonoxidized cut surface is not that high (it is apparently also due to a high reducing ability of propane), and from this standpoint, too, propane is cost efficient.

For the above-described reasons, a good nonoxidized cut surface having metallic gloss and silver white color can be easily obtained by using a mixed gas of nitrogen and propane as the assist gas and combining it with a plasma gas using an inactive gas. Furthermore, propane that is commonly employed as LP gas is not, strictly speaking, pure propane and contains a small amount of butane and the like, but because this factor creates no problems in practical use, the LP gas can be used as propane as referred to in accordance with the present invention.

As for the reason for using nitrogen as the assist gas, similarly to the propane gas, nitrogen is an inactive gas containing no oxygen. Therefore, nitrogen by itself makes no contribution to oxidation of the cut surface. From this standpoint, inactive gases other than nitrogen, for example argon, can be also employed.

Even if the pressure in the nitrogen (inactive gas) line 22 upstream of the merging point 90 in the above-described gas supply system 17 is higher than the pressure in the propane (combustible gas) line 24, the stop valve 26 prevents the nitrogen gas (inactive gas) from flowing into the propane (combustible gas) line 24.

FIG. 2 illustrates a procedure for supplying gases that is executed in the gas supply system 17 in response to instructions from the control unit 50 in the gas supply process for plasma cutting that comprises a series of the pre-flow interval, plasma arc generation interval, and after-flow interval.

The timing of gas supply is different for each gas, as shown in FIG. 2.

At the same time as a start signal is generated in the control unit 50, the electromagnetic valve 30 and electromagnetic valve 32 are opened in response to the instruction from the control unit 50, and the supply of nitrogen gas serving as the plasma gas and nitrogen gas as a component of the assist gas to the plasma torch 2 is started. At this point in time, the plasma arc 14 has not yet been ignited. The gas supply operation prior to the arc ignition is called pre-flow. This operation is implemented after the electromagnetic valves 30, 32 have been opened within an interval in which the gas flow rate in the plasma torch 2 reaches a predetermined value (for example, within 1 to several seconds). In this pre-flow interval, the propane gas that is the component of the assist gas is not supplied to the plasma torch 2. This is done to prevent a large amount of non-combusted propane gas from being released inside the plant.

At the end of the predetermined pre-flow interval, the plasma power source (not shown in the figure) starts operation and ignites the plasma arc 14. At the same time as the generation of the plasma arc 14 is detected (the generation of plasma arc can be detected from the value of the plasma current flowing in the plasma power source, or from a plasma arc voltage applied by the plasma power source between the electrode 4 and the material 16 that is to be cut), the electromagnetic valve 34 is opened in response to the instruction from the control unit 50 and the supply of propane as a component of the assist gas is started. Then, within the interval in which the generation of plasma arc 14 is maintained (in the plasma arc generation interval), nitrogen that is the plasma gas and the mixed gas of propane and nitrogen that is the assist gas are supplied continuous and heat processing such as piercing or cutting of the material 16 is performed. As has already been described hereinabove, because the electromagnetic valve 34 is disposed in the vicinity of the merging point 90, as shown in FIG. 1, and the merging point 90 is disposed in the vicinity of the plasma torch 2 (in other words, because the gas line from the electromagnetic valve 34 to the plasma torch 2 is short), the supply of propane is started in a timely manner without an undesirable delay after the generation of plasma arc 14 has been started.

In the plasma arc generation interval, propane is combusted by coming into contact with the high-temperature plasma arc 14 and high-temperature cut surface formed in the material 16, and the reduction action and shielding action thereof make contribution to the formation of good nonoxidized cut surface. At this time, practically no non-combusted propane gas is released inside the plant.

At the end of the plasma arc generation interval (end of hot processing), the supply of plasma current from a plasma power source is terminated and the plasma arc 14 is quenched. Once the quenching of the plasma arc 14 is detected, the electromagnetic valve 34 is closed by the control unit 50, and the supply of propane as a component of the assist gas is stopped. The operation termed after-flow is then performed. In this operation, only the nitrogen of the plasma gas and nitrogen that is a component of the assist gas are supplied. The after-flow interval is a time (for example from 1 to several seconds) required to cool the final cutting zone to a certain degree to prevent it from oxidation after the plasma arc has been quenched. In the after-flow interval, the supply of propane gas is also terminated. Therefore, the non-combusted propane gas is not released into the plant. At the predetermined end point of the after-flow interval, the start signal is canceled, the electromagnetic valve 30 and electromagnetic valve 32 are closed in response to the instruction from the control unit 50, and the supply of nitrogen of the plasma gas and nitrogen that is a component of the assist gas is terminated. However, as has already been explained, because the electromagnetic valve 34 is disposed in the vicinity of the merging point 90, as shown in FIG. 1, and the merging point 90 is disposed in the vicinity of the plasma torch 2 (in other words, because the gas line from the electromagnetic valve 34 to the plasma torch 2 is short), the supply of propane is started in a timely manner without an undesirable delay after the plasma arc 14 has been quenched.

At the start point in time of the after-flow interval, a mixed gas of propane and nitrogen remains inside the assist gas line 20 on the side of the plasma torch 2 from the merging point 90 shown in FIG. 1. However, as described above, because the merging point 90 is in the vicinity of the plasma torch 2 (as a result, the assist gas line 20 is short and the amount of gas therein is small), the entire residual propane is discharged from the plasma torch 2 into the external atmosphere by the after-flow and no propane remains outside the propane line 24 upstream of the electromagnetic valve 34. The amount of propane discharged at this time is small and causes no problem.

The plasma cutting machine of the above-described configuration can be employed for cutting not only stainless steel, but also soft steel. In this case, for example, the nitrogen line 32 of the gas supply system 17 shown in FIG. 1 can be used as a line for supplying air or oxygen, which is a combustion-supporting gas, as the assist gas. As described above, outside the stainless steel cutting interval, no propane (combustible gas) remains in the assist gas line 20 and, therefore, the combustion-supporting gas causes no problems even when it flows into the nitrogen line 32.

The embodiments of the present invention were described above, but those embodiments merely serve to illustrate the present invention, and the present invention is not limited to those embodiments. Therefore, the present invention can be also carried out in a variety of modes other than the above-described embodiments.

1. A plasma cutting machine for cutting stainless steel, comprising:
a controller for performing control of a gas supply operation; and
a gas supply system for supplying an inactive gas as a plasma gas to be ejected as plasma arc from a nozzle of a plasma torch, and a combustible gas having a specific gravity higher than that of the air and having a reducing ability or a mixed gas of said combustible gas and said inactive gas as an assist gas for shielding said plasma arc from external air to said plasma torch in response to an instruction from said controller.

2. The plasma cutting machine according to claim 1, wherein said combustible gas having said specific gravity higher than that of air and having a reducing ability is propane.

3. The plasma cutting machine according to claim 1, wherein said inactive gas used as said plasma gas is nitrogen.

4. The plasma cutting machine according to claim 1, wherein said assist gas is a mixed gas of nitrogen and propane.

5. The plasma cutting machine according to claim 1, wherein said controller controls said gas supply system so that, from among a series of a pre-flow interval, a plasma arc generation interval, and an after-flow interval, said combustible gas is supplied into said plasma torch in said plasma arc generation interval and the combustible gas is not supplied to the plasma torch in said pre-flow interval or said after-flow interval.

6. The plasma cutting machine according to claim 5, wherein
said gas supply system comprises a plasma gas line for supplying said plasma gas to said plasma torch and an assist gas line for supplying said assist gas to said plasma torch;
said assist gas line is connected to a merging point where a combustible gas line for supplying said combustible gas merges with an inactive gas line for supplying said inactive gas in the vicinity of said plasma torch; and
a gas flow control device for controlling a flow of said combustible gas in response to an instruction from said controller is disposed in said combustible gas line in the vicinity of said merging point.

7. A plasma cutting method applied for cutting stainless steel, comprising the steps of:
supplying an inactive gas as a plasma gas to a plasma torch; and
supplying a combustible gas having a specific gravity higher than that of the air and having a reducing ability or a mixed gas of said combustible gas and said inactive gas as an assist gas to said plasma torch.
